(19) United States
(12) Patent Application Publication
(10) Pub. No.: US 2012/0256874 A1
(43) Pub. Date: Oct. 11, 2012

(54) OPERATION APPARATUS

(75) Inventors: Motoya JIYAMA, Kobe-shi (JP); Naoki SUGAMOTO, Kobe-shi (JP); Nobuyuki BATOU, Kobe-shi (JP); Kiyoshi HAMATANI, Kobe-shi (JP); Kohji MIYAZATO, Kobe-shi (JP); Hiroyuki YANAI, Kobe-shi (JP); Sadaharu YAMAMOTO, Osaka-shi (JP)

(73) Assignee: FUJITSU TEN LIMITED, KOBE-SHI (JP)

(21) Appl. No.: 13/434,301

(22) Filed: Mar. 29, 2012

(30) Foreign Application Priority Data
Apr. 11, 2011 (JP) 2011-087650

(51) Int. Cl. G06F 3/045

(52) U.S. Cl. 345/174

(57) ABSTRACT

A controller acquires an inclination angle, with respect to a vertical direction, of a panel that a user presses for a user operation. The controller corrects a detection value detected by a pressure sensor based on the acquired inclination angle. Then the controller detects a position that the user presses on the panel and a pressure with which the user presses on the panel, based on the detection value, detected by the pressure sensor, which has been corrected.

### BACKGROUND OF THE INVENTION

1. Field of the Invention

The invention relates to a technology that detects a state of a panel operation made by a user.

2. Description of the Background Art

Conventionally, a pressure-sensitive touch panel apparatus that detects a position that a user presses, a pressure with which the user presses, or the both, by using a pressure sensor, has been known as one of operation apparatuses using a touch panel, as an entry method.

For example, one of known conventional technologies is a pressure-sensitive touch panel apparatus that identifies a position that a user presses (operation position), based on a proportion of detection values detected by individual pressure sensors disposed on four (4) corners on a back side of a transparent panel. Moreover, the pressure-sensitive touch panel apparatus using the conventional technology detects a sum value of detection values detected by the individual pressure sensors, as a pressure with which the user presses (operation pressure).

As described above, the conventional pressure-sensitive touch panel apparatus is capable of detecting the operation pressure in addition to the operation position on the panel. Therefore, the pressure-sensitive touch panel apparatus can provide various input operations as compared to a capacitance touch panel apparatus that detects only an operation position.

However, the conventional pressure-sensitive touch panel apparatus has a difficulty in detecting the user operation accurately when the panel including an operation surface is inclined. In other words, when the panel is inclined, gravity exerts an influence on the detection values detected by the individual pressure sensors. Therefore, the operation position and/or the operation pressure detected by the individual pressure sensors may be different from an actual operation position and/or an actual operation pressure.

### SUMMARY OF THE INVENTION

According to one aspect of the invention, an operation apparatus includes: a panel that a user presses for a user operation; a pressure sensor that is disposed in a vicinity of the panel and that senses pressure, on the panel from the user pressing on the panel; and a controller configured to (i) correct a detection value detected by the pressure sensor, in accordance with an inclination angle that is an angle, with respect to a vertical direction, of the panel, and (ii) detect a state of the user operation on the panel, based on the detection value that has been corrected by the controller.

Even when the panel is inclined, the state of the user operation can be detected accurately.

According to another aspect of the invention, the operation apparatus further includes a panel drive configured to change a tilt angle of the panel, and the controller corrects the detection value detected by the pressure sensor, based on the tilt angle of the panel.

Even when the tilt angle of the panel is changed, the state of the user operation can be detected accurately.

According to another aspect of the invention, the operation apparatus further includes a memory that stores a mounting angle that is an angle, with respect to the vertical direction, of the panel mounted to a mounted member, and the controller corrects the detection value detected by the pressure sensor, based on the mounting angle.

Even when the panel is mounted to the mounted member at a tilt, the state of the user operation can be detected accurately.

Therefore, an object of the invention is to detect a state of a user operation accurately even when the panel is inclined.

These and other objects, features, aspects and advantages of the invention will become more apparent from the following detailed description of the invention when taken in conjunction with the accompanying drawings.

### BRIEF DESCRIPTION OF THE DRAWINGS

FIG. 1A illustrates an outline of a pressure-sensitive touch panel apparatus;

FIG. 1B illustrates a situation where a touch panel is affected by gravity;

FIG. 1C illustrates an outline of an operation detection method;

FIG. 2 illustrates a configuration of a navigation apparatus relating to a first embodiment;

FIG. 3 illustrates a tilt function;

FIG. 4 illustrates an example of a correction table;

FIG. 5 is a flowchart showing a procedure of an operation detection process;

FIG. 6 illustrates a situation where a mounting surface of a mounted member is inclined;

FIG. 7 is a flowchart showing a procedure of an inclination-angle identification process relating to a second embodiment;

FIG. 8 is a flowchart showing a procedure of a mounting-angle determination process;

FIG. 9 illustrates an example in a calibration process;

FIG. 10 illustrates a situation where a host vehicle on which a navigation apparatus is mounted is inclined;

FIG. 11 is a block diagram that illustrates a configuration of a navigation apparatus relating to a third embodiment;

FIG. 12 illustrates an example in a vehicle-angle derivation process;

FIG. 13 illustrates a situation example where a touch panel is affected by an inertial force; and

FIG. 14 is a flowchart showing a procedure of a correction-value changing process.

### DESCRIPTION OF THE EMBODIMENTS

Embodiments of an operation apparatus relating to the invention are hereinafter described in detail, with reference to the attached drawings. However, the invention is not limited to examples in the embodiments.

### <1. Outline of Operation Detection Method>

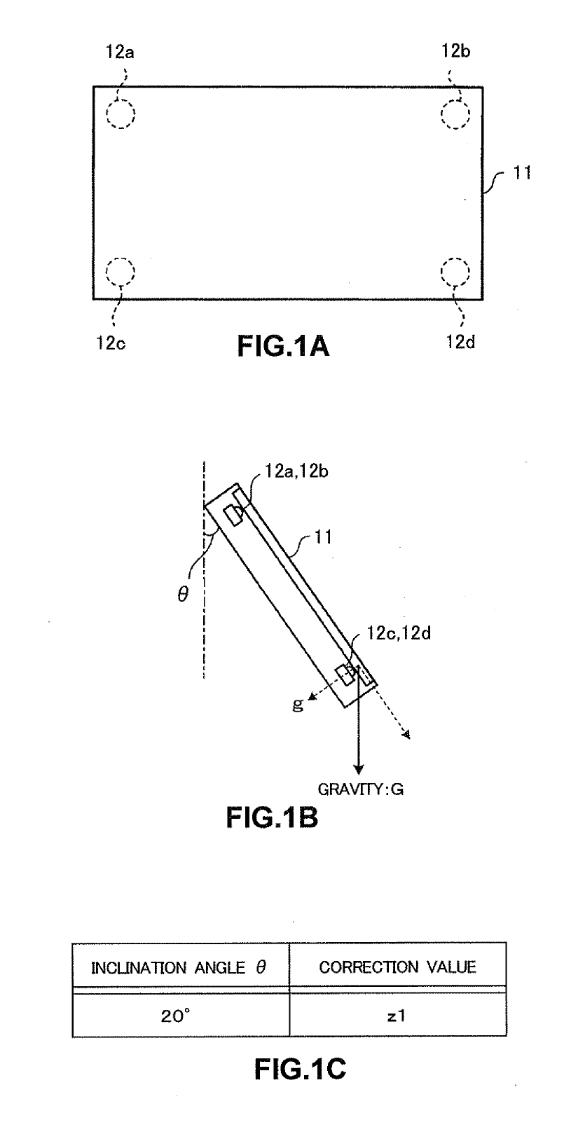

First, an outline of an operation detection method relating to the embodiments is explained with reference to FIG. 1A to FIG. 1C. FIGS. 1A to 1C are drawings for explaining the outline of the operation detection method relating to the embodiments. FIG. 1A illustrates an outline of a pressure-sensitive touch panel apparatus. FIG. 1B illustrates a situation where a panel 11 including an operation surface is affected by gravity G. FIG. 1C illustrates an outline of an operation detection method. In the embodiments, a navigation apparatus having an audio-visual function is used as an example of an operation apparatus for which the operation detection method is used.

As shown in FIG. 1A, the pressure-sensitive touch panel apparatus is a touch panel that detects a position of an operation made by a user to the panel 11, by using pressure sensors 12a, 12b, 12c, and 12d. Concretely, the pressure-sensitive touch panel apparatus includes the transparent panel 11 having the operation surface, and the pressure sensors 12a to 12d disposed in vicinities of four (4) corners on the back side of the panel 11. The pressure sensors 12a to 12d sense pressure on the panel 11 from the user pressing on the panel 11 (i.e. operation pressure). The pressure-sensitive touch panel apparatus detects a position which the user presses (i.e. operation position) on the panel 11, based on a proportion of detection values detected by the individual pressure sensors 12a to 12d. For example, when the panel 11 is rectangular and when the detection values detected by the pressure sensors 12a to 12d are the same, the pressure-sensitive touch panel apparatus detects that the user has pressed a center of the panel 11.

A display, such as a LCD (Liquid Crystal Display), not illustrated in FIG. 1A, is disposed behind the pressure sensors 12a to 12d. The user presses a desired position on the panel 11 based on an image displayed on the display.

Moreover, the pressure-sensitive touch panel apparatus is also capable of detecting a pressure of the user operation to the panel 11. For example, the pressure-sensitive touch panel apparatus identifies a sum value of the detection values detected by the individual pressure sensors, as the operation pressure. As a result, a screen on the panel 11 can be switched to a different screen in accordance with the operation pressure, or an amount of adjustment, such as brightness and volume, can be changed in accordance with the operation pressure.

There is a case where a conventional pressure-sensitive touch panel apparatus has a difficulty in detecting a state of the user operation accurately when the panel 11 including the operation surface is inclined. As shown in FIG. 1B, when the panel 11 is inclined, a component of the gravity G (a component g in a direction normal to the operation surface of the panel 11) is added to the detection values detected by the individual pressure sensors 12a to 12d. As a result, there is a possibility that the operation position and/or the operation pressure detected by the individual pressure sensors is/are different from the actual operation position and/or the actual operation pressure. Therefore, when an inclination angle θ that is an angle of the panel 11 with respect to a vertical direction (a direction of the gravity G) is a degree other than zero degree (0°), there is a case where accurate detection of the user operation is difficult.

Especially, when the pressure-sensitive touch panel apparatus includes a tilt function that changes the inclination angle θ of the panel 11, the inclination angle θ of the panel 11 may be changed by the tilt function. Moreover, when the pressure-sensitive touch panel apparatus is used as an in-vehicle operation apparatus, the inclination angle θ of the panel 11 may change as a host vehicle travels. In such a case, an influence of the gravity G on the pressure sensors 12a to 12d also changes, and incorrect detections may increase due to unstable deviation from the actual operation position and/or the actual operation pressure.

Therefore, the operation detection method in the embodiments identifies the inclination angle θ of the panel 11 and corrects the detection values detected by the individual pressure sensors 12a to 12d, in accordance with the inclination angle θ identified, and then detects the operation position and operation pressure based on the detection values corrected.

For example, as shown in FIG. 1C, when the inclination angle θ of the panel 11 is 20°, a correction value z1 is subtracted from each of the detection values detected by the individual pressure sensors 12a to 12d, and the operation position and the operation pressure are detected, based on the detection values from which the correction value z1 has been subtracted.

Here, the correction value z1 is equal to a load applied to the individual pressure sensors 12a to 12d when the panel 11 is inclined at 20°. The influence of the gravity G can be removed from the detection values detected by the individual pressure sensors 12a to 12d by subtracting the load from the detection values detected by the individual pressure sensors 12a to 12d, and an obtained detection result is the same as a detection result obtained when the panel 11 is not inclined.

In such a manner, the operation detection method in the embodiments identifies the inclination angle θ of the panel 11 and corrects the detection values detected by the individual pressure sensors 12a to 12d in accordance with the identified inclination angle θ of the panel 11, and then detects the operation position and the operation pressure on the panel 11 based on the detection values corrected. Therefore, according to the invention, even when an operation surface is inclined, the state of the user operation can be detected accurately.

In the operation detection method, when the pressure-sensitive touch panel apparatus includes the tilt function, an angle of the panel 11 changed by the tilt function (hereinafter referred to as “tilt angle”) may be identified as the inclination angle θ of the panel 11. A case where the pressure-sensitive touch panel apparatus has the tilt function will be later described in a first embodiment.

There is a case where a mounting surface to which the pressure-sensitive touch panel apparatus is mounted is inclined. Therefore, in the operation detection method, the inclination angle θ of the panel 11 may be identified by using the tilt angle and an inclination angle of the mounting surface (hereinafter referred to as “mounting angle”). When the mounting angle is known, the known mounting angle may be used. Otherwise, the mounting angle may be determined by using a gyroscope, etc. A case where the mounting surface is inclined will be later described in a second embodiment.

Moreover, when the pressure-sensitive touch panel apparatus is mounted on a host vehicle, the inclination angle θ of the panel 11 is changed due to an inclination of the host vehicle. Therefore, in the operation detection method, the inclination angle θ of the panel 11 may be identified further taking into consideration an inclination angle of the host vehicle (hereinafter referred to as “vehicle angle”). A case where the host vehicle is inclined will be later described in a third embodiment.

An operation apparatus using the operation detection method is hereinafter explained in detail. The following embodiments are examples where the operation detection method is applied to a navigation apparatus. However, the operation apparatus relating to the invention can be applied to apparatuses other than navigation apparatuses.

### <2. First Embodiment>

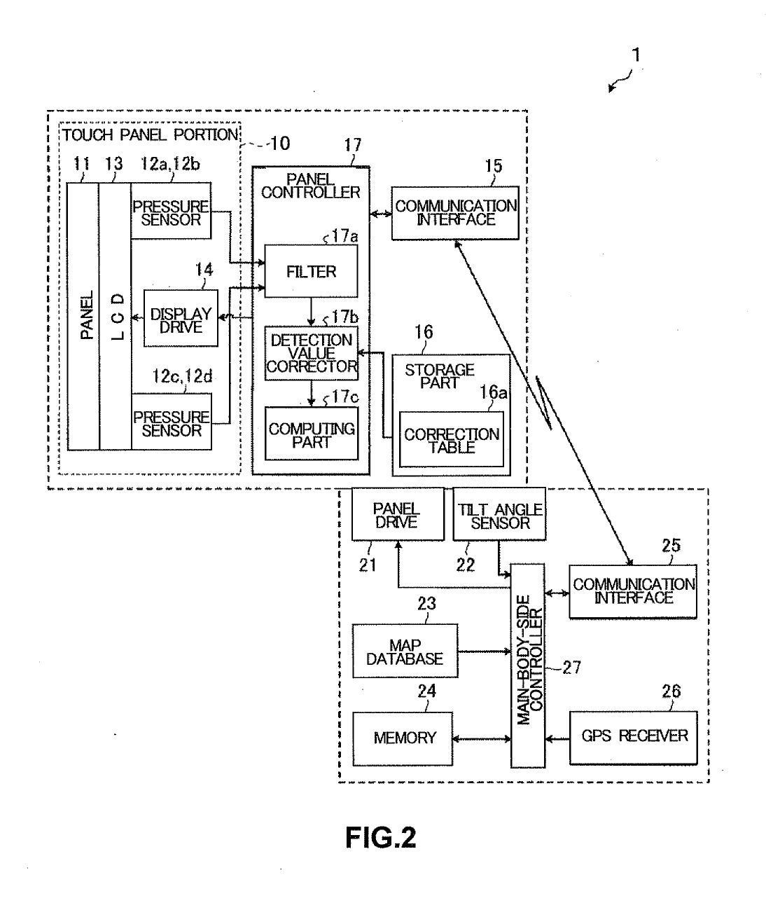

The first embodiment is hereinafter described. First, a configuration of a navigation apparatus relating to the embodiment is explained with reference to FIG. 2. FIG. 2 is a block diagram that illustrates a configuration of a navigation apparatus 1 relating to the embodiment. FIG. 2 illustrates only components necessary for explaining characteristics of the navigation apparatus 1, and general components as a navigation apparatus are omitted.

As shown in FIG. 2, the navigation apparatus 1 includes a panel 11, pressure sensors 12a to 12d, a LCD 13, a display drive 14, a communication interface 15, a storage part 16, and a panel controller 17. Moreover, the storage part 16 stores a correction table 16a. The panel controller 17 includes a filter 17a, a detection value corrector 17b, and a computing part 17c.

The navigation apparatus 1 further includes a panel drive 21, a tilt angle sensor 22, a map database 23, a memory 24, a communication interface 25, a GPS (Global Positioning System) receiver 26, and a main-body-side controller 27.

The panel 11 is a member in a form of a plate made of a transparent material such as glass. A front surface of the panel 11 is an operation surface that receives a pressing operation made by a user. Moreover, the pressure sensors 12a to 12d are individually disposed on four (4) corners of a back side of the panel 11.

The pressure sensors 12a to 12d are detectors that detect a load applied to the panel 11 by the pressing operation made by the user. The pressure sensors are implemented by, for example, piezoelectric elements. Individual detection values detected by the individual pressure sensors 12a to 12d are input to the filter 17a.

There is a case where the detection values detected by the individual pressure sensors 12a to 12d include a load other than the load applied to the panel 11 by the pressing operation made by the user. For example, when the panel 11 is inclined, the detection values detected by the individual pressure sensors 12a to 12d include a weight of the panel 11 itself, in a proportion according to an inclination angle of the panel 11. In such a case, an operation position and/or an operation pressure detected by the individual pressure sensors 12a to 12d may be different from an actual operation position and/or an actual operation pressure.

The LCD 13 is a display that has a plurality of pixels arrayed in a matrix pattern and that displays an image by modulating light incident from a predetermined light source, per pixel, based on a control signal sent from the display drive 14. The display drive 14 is, for example, a LCD driver, and acquires image data from the panel controller 17 and then displays an image based on the image data acquired from the panel controller 17, on the LCD 13.

Moreover, as shown in FIG. 2, a touch panel portion 10 includes, for example, the panel 11, the pressure sensors 12a to 12d, the LCD 13, and the display drive 14.

The communication interface 15 is a communication device for allowing the panel controller 17 to communicate data with the main-body-side controller 27.

The panel drive 21 is a mechanical part that drives the entire touch panel portion 10 in accordance with a command sent from the main-body-side controller 27, and includes a motor, various types of gear, etc. Therefore, the navigation apparatus 1 is capable of changing the inclination angle (a tilt angle) of the panel 11 included in the touch panel portion 10, by using the panel drive 21.

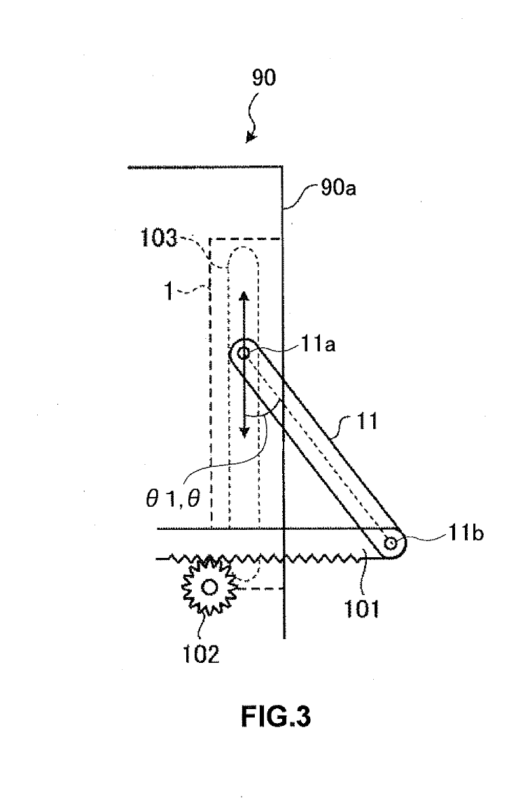

Here, a tilt function of the navigation apparatus 1 is explained with reference to FIG. 3. FIG. 3 explains the tilt function. As shown in FIG. 3, the navigation apparatus 1 is mounted in a predetermined storage space provided in a dashboard 90 that serves as a mounted member for the navigation apparatus 1, in a host vehicle. The panel drive 21 changes the tilt angle θ1 of the panel 11 to plural tilt levels in accordance with a command sent from the main-body-side controller 27.

Concretely, the panel drive 21 includes a rack 101 that has a toothed side, and a pinion gear 102 that engages with the rack 101 and that turns as a motor, not illustrated, turns. The panel 11 is supported at an upper end 11a of the panel 11, to be slidable in a guide groove 103 provided to the navigation apparatus 1, and is supported by the rack 101 at a lower end 11b of the panel 11.

The panel drive 21 turns the motor (e.g. stepping motor), not illustrated, by a predetermined degree, in accordance with the command sent from the main-body-side controller 27. As a result, the pinion gear 102 turns as the motor turns. Moreover, the rack 101 moves linearly as the pinion gear 102 turns. Thus, the tilt angle θ1 of the panel 11 is changed.

For example, the tilt angle θ1 can be changed to four (4) levels of 0°, 20°, 40°, and 60°. A tilt level 0 (zero) denotes that the tilt angle θ1 is 0°. A tilt level 1 denotes that the tilt angle θ1 is 20°. A tilt level 2 denotes that the tilt angle θ1 is 40°. A tilt level 3 denotes that the tilt angle θ1 is 60°.

When changing the tilt angle θ1 of the panel 11, the user changes the tilt level step by step, by pressing the panel 11 or a hard switch provided to the touch panel portion 10. For example, the user presses the panel 11 or the hard switch twice for changing the tilt angle θ1 from 0° to 40°.

Moreover, the main-body-side controller 27 outputs a driving command for driving the panel 11 (the touch panel portion 10) to the panel drive 21 every time when receiving a change operation (a pressing operation) of the tilt level, made by the user.

Then the panel drive 21 moves the panel 11 by a determined angle (in this case, by 20°) every time when receiving the driving command from the main-body-side controller 27. The driving command includes an instruction about a moving direction in which the panel 11 is angled (a direction for increasing the tilt angle θ1 or for decreasing the tilt angle θ1). The panel drive 21 moves the panel 11 in the direction instructed by the driving command.

When receiving the driving command to increase the tilt angle θ1 of 60°, or when receiving the driving command to decrease the tilt angle θ1 of 0°, the panel drive 21 does not move the panel 11.

After moving the panel 11, the panel drive 21 outputs a drive completion notice including the moving direction for the panel 11, to the tilt angle sensor 22.

As shown in FIG. 3, in the first embodiment, a mounting surface 90a to which the navigation apparatus 1 is mounted stands along a vertical direction. In other words, when the tilt angle θ1=0°, the pressure sensors 12a to 12d are not affected by the gravity G.

With reference back to FIG. 2, the tilt angle sensor 22 will be described. The tilt angle sensor 22 is a processing part that detects the tilt angle θ1 of the panel 11 at a present time point, based on an output history of the drive completion notice output from the panel drive 21.

For example, when receiving three times the drive completion notice representing that the panel 11 has been moved in the direction for increasing the tilt angle θ1 from 0°, the tilt angle sensor 22 identifies that the tilt angle θ1 is 60° at the present time point.

Moreover, when receiving twice the drive completion notice representing that the panel 11 has been moved in the direction for decreasing the tilt angle θ1 from 60°, the tilt angle sensor 22 identifies that the tilt angle θ1 is 20° at the present time point.

When identifying the tilt angle θ1 at the present time point, the tilt angle sensor 22 outputs the tilt angle θ1 identified to the main-body-side controller 27. The main-body-side controller 27 outputs the tilt angle θ1 identified to the detection value corrector 17b of the panel controller 17 via the communication interface 25.

The tilt angle sensor 22 is not limited to the tilt angle sensor mentioned above, but may include a potentiometer that detects a rotation angle of the pinion gear 102 (or of a motor rotation axis) or may include a rotary switch, a light sensor, or the like.

Moreover, the example described above is an exemplary case where the user changes the tilt levels one by one. However, a method of changing the tilt level is not limited to the step-by-step method mentioned above, but may be a method of changing the tilt level by selecting a desired tilt level by one operation. In this case, the main-body-side controller 27 is capable of identifying a tilt level (i.e. the tilt angle θ1) at a present time point without receiving the drive completion notice from the tilt angle sensor 22. Therefore, the tilt angle sensor 22 is not necessary.

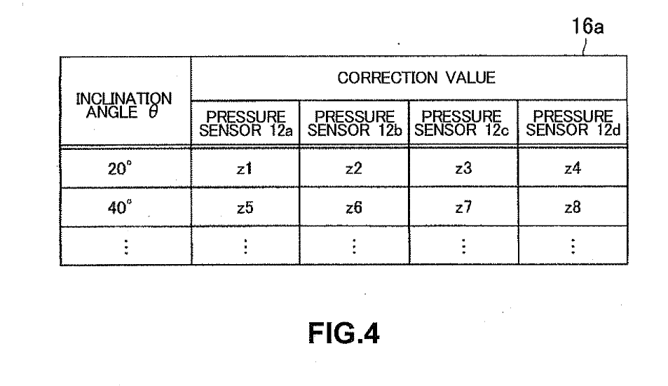

The storage part 16 is a memory that includes a memory device such as a nonvolatile memory and a hard disc drive, and stores the correction table 16a. Here, details of the correction table 16a are described with reference to FIG. 4. FIG. 4 illustrates an example of the correction table 16a.

As shown in FIG. 4, the correction table 16a has correction values related to each of plural inclination angles θ (the tilt angles θ1 in the first embodiment) of the panel 11. The correction values are correction information used for correcting the detection values detected by the individual pressure sensors 12a to 12d. For example, for the tilt angle θ1 of 20° in the correction table 16a shown in FIG. 4, correction values z1, z2, z3, and z4 are related, as the correction values, to the detection values detected by the individual pressure sensors 12a to 12d, respectively. Moreover, for the tilt angle θ1 of 40°, correction values z5, z6, z7, and z8 are related, as the correction values, to the detection values detected by the individual pressure sensors 12a to 12d, respectively.

Here, the correction values stored in the correction table 16a are loads applied to the individual pressure sensors 12a to 12d in a state where the panel 11 is inclined at a related tilt angle with no operation made by the user to the panel 11. The loads are attributed to the gravity G

The correction table 16a is prepared, for example, before shipping of a product in which the navigation apparatus 1 is mounted. Concretely, the navigation apparatus 1 is mounted such that the panel 11 stands along the vertical direction having the tilt angle θ1 at 0°. Then the detection values detected by the individual pressure sensors 12a to 12d are actually measured at each tilt angle θ1 (i.e. 0°, 20°, 40°, and 60°) in a state where the user does not operate the panel 11. The correction table 16a is generated by relating the individual detection values obtained from the measurement as the correction values, to a corresponding tilt angle θ1.

A method in which the correction table 16a is generated is not limited to the method mentioned above, but the correction table 16a may be generated by performing a predetermined calibration process when the navigation apparatus 1 mounted on the host vehicle is first activated. An exemplary calibration process will be later described in the second embodiment.

In this embodiment, the correction values for each inclination angle θ are stored in the correction table, as the correction information, and the correction values retrieved from the correction table are used for the correction process. On the other hand, the correction values that are used for the correction process may be obtained by storing a correction arithmetic expression as the correction information and by substituting a parameter into the correction arithmetic expression. When a correction arithmetic expression is used for the correction process, a correction method that uses the tilt angle θ1 as the parameter is usable. Moreover, as shown in embodiments described later, when the inclination angle θ of the panel 11 is defined by plural angles, the inclination angle θ defined by the plural angles is used as the parameter for the correction arithmetic expression.

With reference back to FIG. 2, the panel controller 17 is described. The panel controller 17 includes the filter 17a, the detection value corrector 17b, and the computing part 17c.

The filter 17a is a processing part that removes a noise component included in the detection values input from the pressure sensors 12a to 12d. Here, the noise component means a small fluctuation of the detection values, caused by, for example, the host vehicle vibration.

The filter 17a outputs the detection values from which the noise component has been removed, to the detection value corrector 17b. The filter 17a may include a low pass filter (LPF) or the like that removes, for example, a high frequency component.

A frequency band including an output signal sent from the pressure sensors due to a user operation is lower than a frequency band including an output signal sent from the pressure sensor due to the host vehicle vibration. Therefore, the noise component generated by the host vehicle vibration can be effectively removed by removing the component in a frequency band higher than the main frequency band including the output signal sent due to the user operation.

The detection value corrector 17b is a processing part that receives the detection values detected by the individual pressure sensors 12a to 12d, from the touch panel portion 10, and that corrects the detection values received, based on the inclination angle θ of the panel 11 and the correction table 16a stored in the storage part 16. The detection value corrector 17b in the first embodiment uses the tilt angle θ1 provided from the tilt angle sensor 22 via the main-body-side controller 27, as the inclination angle θ of the panel 11.

The detection value corrector 17b determines the correction values corresponding to the inclination angle θ (the tilt angle θ1) of the panel 11, based on the correction table 16a. For example, the detection value corrector 17b refers to the correction table 16a (refer to FIG. 4) and determines the z1 to z4 as the correction values for the detection values detected by the individual pressure sensors 12a to 12d, respectively, when the inclination angle θ of the panel 11 is 20°.

Next, the detection value corrector 17b subtracts the correction values z1 to z4 determined, from the detection values detected by the corresponding pressure sensors 12a to 12d, respectively. Concretely, the detection value corrector 17b subtracts the correction value z1 from the detection value detected by the pressure sensor 12a. The detection value corrector 17b subtracts the correction value z2 from the detection value detected by the pressure sensor 12b. The detection value corrector 17b subtracts the correction value z3 from the detection value detected by the pressure sensor 12c. Moreover, the detection value corrector 17b subtracts the correction value z4 from the detection value detected by the pressure sensor 12d.

The detection value corrector 17b outputs the detection values from which the correction values have been subtracted, to the computing part 17c, as corrected detection values of the individual pressure sensors 12a to 12d. Thus, the computing part 17c computes the operation position and the operation pressure, based on the detection values corrected by the detection value corrector 17b.

The correction table 16a is not necessarily required to have the correction values relating to all the tilt angles θ1. For example, the correction table 16a may have the correction values relating only to the tilt angles θ1 of 20° and 60°. In such a case, the detection value corrector 17b, for example, may compute the correction values for the tilt angle of 40° by an interpolation processing (e.g. linear interpolation) by using the correction values for the tilt angles of 20° and 60°.

The computing part 17c is a processing part that detects a state of a user operation (the operation position and the operation pressure) to the panel 11 based on the corrected detection values of the individual pressure sensors 12a to 12d. Concretely, the computing part 17c detects the operation position and the operation pressure by performing a predetermined arithmetic processing, based on the corrected detection values of the individual pressure sensors 12a to 12d.

For example, the computing part 17c derives a coordinate of the operation surface of the panel 11 as the operation position, based on a mutual proportion of the corrected detection values of the four pressure sensors 12a to 12d. Moreover, the computing part 17c derives a sum value of the corrected detection values of the four pressure sensors 12a to 12d as the operation pressure. However, any conventional known art may be used for an arithmetic expression for obtaining the operation position and the operation pressure.

The panel controller 17 notifies the main-body-side controller 27 of the coordinate and the pressure derived by the computing part 17c, as the operation position and the operation pressure, respectively. Thus, the main-body-side controller 27 performs a function corresponding to the user operation, based on the operation position and/or on the operation pressure notified by the panel controller 17.

The map database 23 is map information, including road data, facility data, etc, for navigation. The map database 23 includes altitude information of each point. The altitude information will be described later in a third embodiment.

The memory 24 is a memory that includes a memory device such as a nonvolatile memory and a hard disc drive. The communication interface 25 is a communication device for allowing the main-body-side controller 27 to communicate data with the panel controller 17. The GPS receiver 26 acquires position information of the host vehicle from a satellite, etc. and outputs the position information acquired to the main-body-side controller 27.

The main-body-side controller 27 performs a function corresponding to the user operation, based on the operation position and/or on the operation pressure provided by the panel controller 17 via the communication interface 25. For example, the main-body-side controller 27 changes the tilt angle θ1 of the panel 11 by driving the panel drive 21, based on the operation position and/or on the operation pressure provided by the panel controller 17.

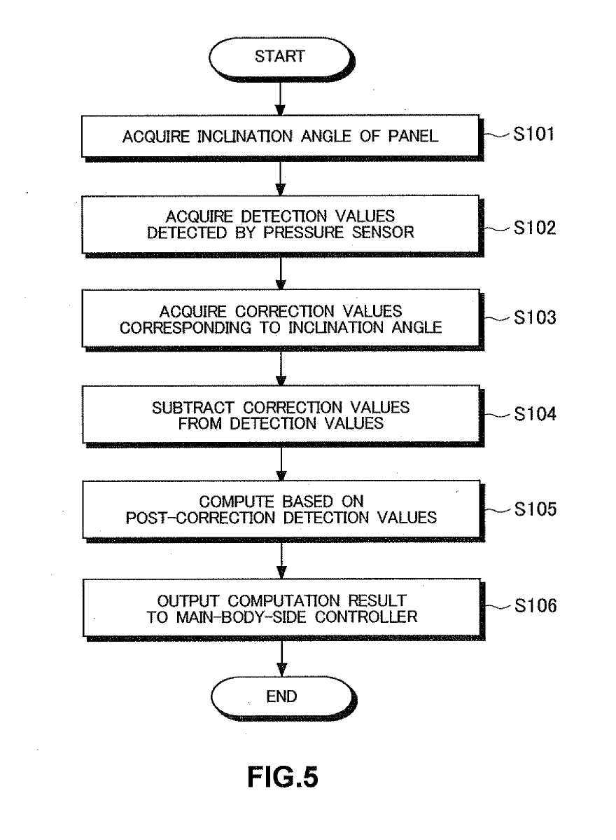

Next, a procedure of an operation detection process performed by the navigation apparatus 1 is described with reference with FIG. 5. FIG. 5 is a flowchart showing the procedure of the operation detection process. The operation detection process is performed when the pressing operation is performed to the panel 11.

The operation detection process is performed by a microcomputer included in the panel controller 17, based on a program stored in a memory (not illustrated in the drawing). For easy understanding of a relationship between the operation detection process and each function of the panel controller 17, information identifying a function part that performs a step of the operation detection process will be described in parentheses. The information identifying a function will be also described in parentheses in explanations of other flowcharts.

As shown in FIG. 5, in the navigation apparatus 1, the panel controller 17 (the detection value corrector 17b) first acquires the inclination angle θ of the panel 11 (a step S101). In the first embodiment, the tilt angle θ1 provided from the tilt angle sensor 22 via the main-body-side controller 27 is acquired as the inclination angle θ of the panel 11.

Next, the panel controller 17 (the detection value corrector 17b) acquires the detection values detected by the individual pressure sensors 12a to 12d output via the filter 17a (a step S102). Then, the panel controller 17 (the detection value corrector 17b) refers to the correction table 16a stored in the storage part 16 and acquires the correction values corresponding to the inclination angle θ of the panel 11, from the correction table 16a (a step S103). The panel controller 17 (the detection value corrector 17b) subtracts the correction values acquired, from the individually corresponding detection values detected by the individual pressure sensors 12a to 12d (a step S104).

Next, the panel controller 17 (the computing part 17c) computes the operation position and the operation pressure, based on each of the corrected detection values (a step S105). Then, the panel controller 17 outputs the computation result to the main-body-side controller 27 via the communication interface 15 (a step S106), and the process ends.

As described above, in the first embodiment, the detection value corrector 17b corrects the detection values detected by the individual pressure sensors 12a to 12d, in accordance with the inclination angle θ (the tilt angle θ1) of the panel 11. Therefore, even when the operation surface of the panel 11 is inclined, the user operation can be detected accurately.

Moreover, in the first embodiment, the tilt angle θ1 of the touch panel portion 10 changed by the panel drive 21 is identified as the inclination angle θ of the panel 11. Thus, even when the inclination angle θ of the panel 11 is changed by the change of the tilt angle θ1, an incorrect detection caused by the gravity G, of the operation position and/or the operation pressure, can be prevented.

Furthermore, in the first embodiment, the storage part 16 stores the correction table 16a having the correction values for the detection values detected by the pressure sensors 12a to 12d, for each of the plural inclination angles θ of the panel 11. And then the detection value corrector 17b acquires the correction values according to the inclination angle (the tilt angle θ1) of the panel 11 at a present time point, from the correction table 16a, and corrects the detection values detected by the pressure sensors 12a to 12d, by using the correction values acquired.

Thus, an influence of the gravity G exerting on the individual pressure sensors 12a to 12d in accordance with the inclination angle θ of the panel 11 at the present time point can be removed appropriately from the detection values detected by the individual pressure sensors 12a to 12d. Therefore, a detection result same as a detection result obtained when the panel 11 is not inclined can be obtained.

### <3. Second Embodiment>

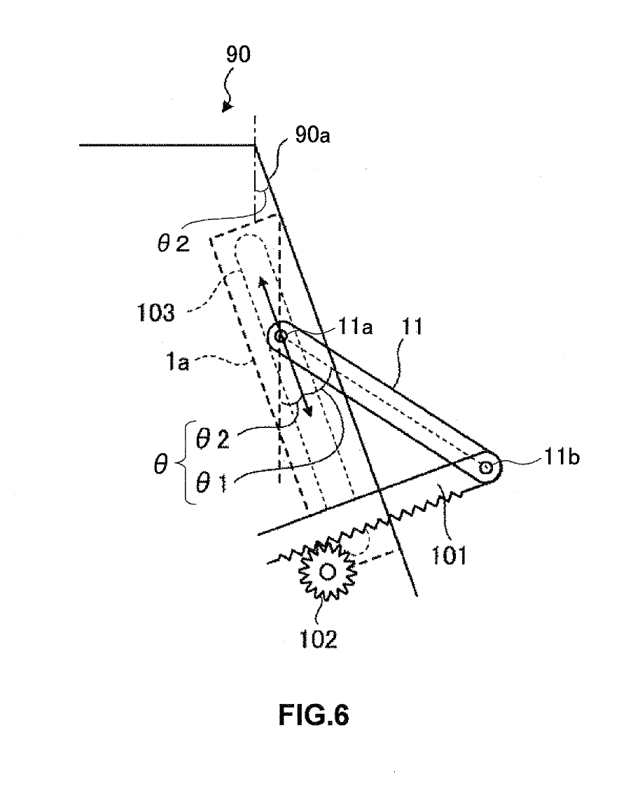

Next described is the second embodiment. In the first embodiment described above, the tilt angle θ1 of the touch panel portion 10 is used as the inclination angle θ of the panel 11. However, when a mounting surface 90a itself of a dashboard 90 is inclined, a navigation apparatus is mounted at a tilt. In such a case, it is difficult to identify an accurate inclination angle θ of the panel 11 only by using the tilt angle θ1. FIG. 6 illustrates a situation where the mounting surface 90a to which a navigation apparatus 1a is mounted is inclined. In FIG. 6, a host vehicle on which the navigation apparatus 1a is mounted is in a horizontal position.

As shown in FIG. 6, the mounting surface 90a of the dashboard 90 that serves as a mounted member to which the navigation apparatus 1a is mounted, is inclined at an angle θ2 with respect to a vertical direction. In such a case, the navigation apparatus 1a is mounted to the dashboard 90 of the host vehicle, having a panel 11 inclined at the angle θ2 with respect to the vertical direction. As a result, an actual inclination angle θ of the panel 11 is a sum value of a tilt angle θ1 and the inclination angle θ2 of the mounting surface 90a.

In the second embodiment, the sum value of the tilt angle θ1 and the inclination angle θ2 of the mounting surface 90a is used as the inclination angle θ of the panel 11. The inclination angle θ2 (an angle with respect to the vertical direction) of the mounting surface 90a when the host vehicle is in the horizontal position is hereinafter referred to as a mounting angle θ2. The mounting angle θ is also an angle of the panel 11 with respect to the vertical direction in a state where the panel 11 is mounted to the dashboard 90 and where the tilt angle θ1 is 0°. Moreover, in the second embodiment, the host vehicle is supposed to be in the horizontal position.

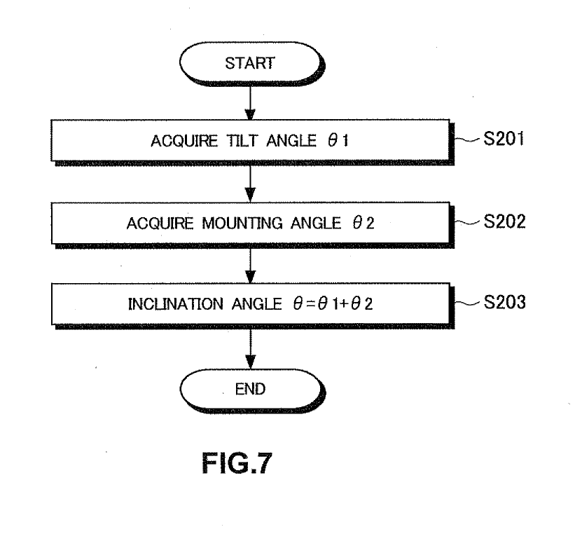

First, a procedure of a process that identifies the inclination angle (inclination-angle identification process) relating to the second embodiment is described with reference to FIG. 7. FIG. 7 is a flowchart showing the procedure of the inclination-angle identification process relating to the second embodiment.

As shown in FIG. 7, a panel controller 17 (a detection value corrector 17b) acquires the tilt angle θ1 from a tilt angle sensor 22 (a step S201) and the mounting angle θ2 stored in a predetermined memory (e.g. a storage part 16) (a step S202).

Then, the panel controller 17 (the detection value corrector 17b) identifies the sum value (θ1+θ2) of the tilt angle θ1 and the mounting angle θ2, as the inclination angle θ of the panel 11 (a step S203), and the process ends.

Here, the mounting angle θ2 may be measured after the navigation apparatus 1a is mounted to a product, and the mounting angle θ2 measured may be stored in the storage part 16 or the like. For example, the navigation apparatus 1a is capable of identifying the mounting angle θ2 by using a gyroscope built in the navigation apparatus 1a.

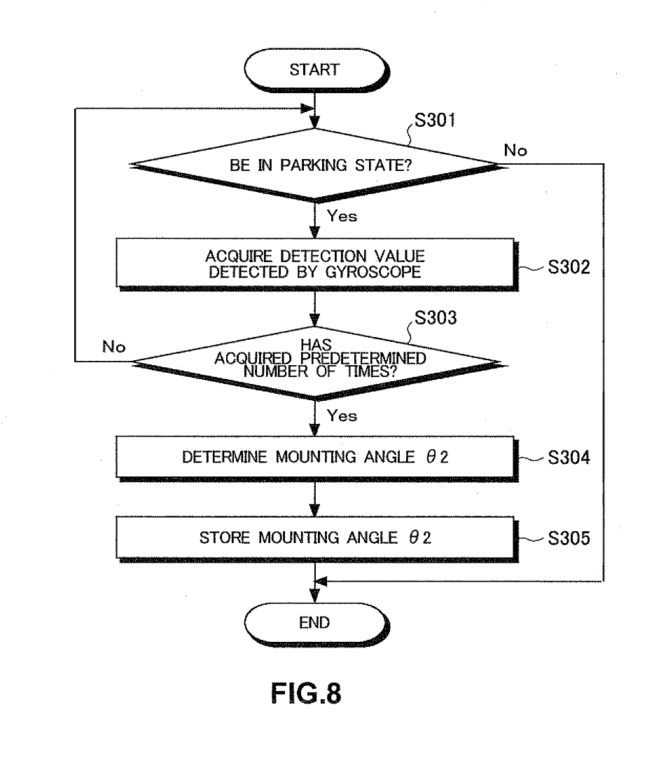

A procedure of a process that determines the mounting angle (mounting-angle determination process) by using the gyroscope is hereinafter described with reference to FIG. 8. FIG. 8 is a flowchart showing the procedure of the mounting-angle determination process. The process is repeated while the navigation apparatus 1a is on.

As shown in FIG. 8, in the navigation apparatus 1a, the panel controller 17 determines whether or not the host vehicle is in a parking state (a step S301). When the host vehicle is not in the parking state (No in the step S301), the process ends. When the panel controller 17 determines that the host vehicle is in the parking state (Yes in the step S301), the panel controller 17 acquires a detection value detected by the gyroscope (a step S302). The detection value detected by the gyroscope is identified as an inclination angle of the navigation apparatus 1a with respect to a horizontal direction in a state where the host vehicle is in the parking state.

A determination process in the step S301 may be performed based on a position of a shift lever or of a parking brake, on fastening or unfastening of a seat belt, and on a detection result detected by a vehicle speed sensor, etc., built in the navigation apparatus 1a.

Next, the panel controller 17 determines whether or not the inclination angle of the navigation apparatus 1a has been acquired a predetermined number of times (e.g. 10 times) in the parking state (a step S303). When the inclination angle of the navigation apparatus 1a has not been acquired the predetermined number of times (No in the step S303), the process from the step S301 to the step S303 is repeated.

When the inclination angle of the navigation apparatus I a has been acquired the predetermined number of times in the parking state (Yes in the step S303), the panel controller 17 determines the mounting angle θ2 based on the inclination angle acquired (a step S304). For example, the panel controller 17 determines an average value of the inclination angles acquired by the navigation apparatus 1a, as the mounting angle θ2.

As described above, the inclination angle of the navigation apparatus with respect to the vertical direction, in other words, the mounting angle θ2, can be determined by acquiring the detection value detected by the gyroscope in the parking state where the host vehicle is a horizontal position in many cases, and by averaging the detection values detected plural number of times. The panel controller 17 stores the mounting angle θ2 determined into a predetermined memory (e.g. the storage part 16) (a step S305), and the process ends.

The plural mounting angles θ2 may be stored in the storage part 16 and the like, in advance before shipping of the navigation apparatus 1a. For example, the navigation apparatus 1a is capable of identifying an actual mounting angle θ2 in accordance with a model of the host vehicle, by a user selecting the model of the host vehicle out of car models of which plural different mounting angles θ2 are stored beforehand in the navigation apparatus 1a.

As described above, in the second embodiment, the mounting angle θ2 of the mounted member is stored in a memory such as the storage part 16, and the detection value corrector 17b corrects the detection values detected by the pressure sensors 12a to 12d, based on the mounting angle θ2 stored in the memory. Therefore, even when the navigation apparatus 1a is mounted at a tilt, the inclination angle θ of the panel 11 can be identified accurately.

Like the detection value corrector 17b in the first embodiment, the detection value corrector 17b in the second embodiment corrects the detection values detected by the individual pressure sensors 12a to 12d by using the inclination angle θ of the panel 11 and the correction table 16a stored in the storage part 16.

Since the inclination angle θ of the panel 11 is the sum value of the tilt angle θ1 and the mounting angle θ2, an angle corresponding to the sum value is not included in the correction table 16a in many cases. However, in such a case, the correction values corresponding to the inclination angle θ of the panel 11 (the sum value of the tilt angle θ1 and the mounting angle θ2) may be computed by interpolation.

Moreover, the function of computing the correction values can be also realized in a method where plural correction tables individually corresponding to the plural mounting angle θ2 are stored and where one of the plural correction tables, corresponding to a mounting angle θ2 identified, is used as the correction table 16a to be used for actual correction.

In the aforementioned description, the correction table 16a is stored beforehand. However, the correction table may be generated by performing a predetermined calibration process in a state where the navigation apparatus 1a is mounted in the host vehicle.

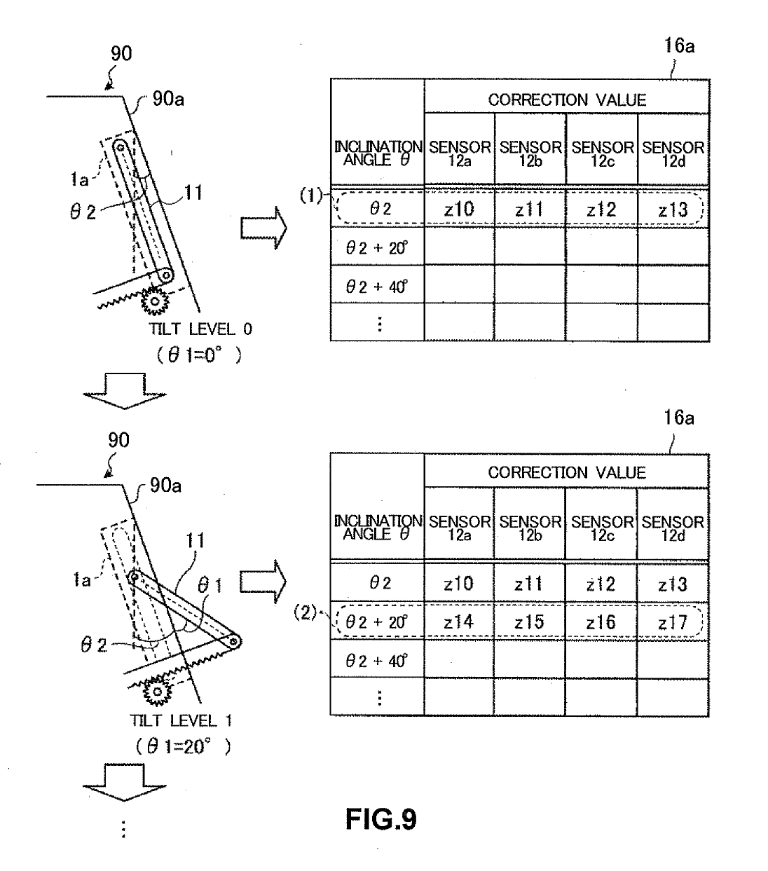

The calibration process is hereinafter described with reference to FIG. 9. FIG. 9 illustrates an example of the calibration process.

As shown in FIG. 9, the navigation apparatus 1a performs the predetermined calibration process, for example, when the navigation apparatus 1a is first activated after being mounted to the host vehicle. Concretely, the panel controller 17 increases a tilt level from zero step by step and stores the detection values (detection values with no user operation) detected by the pressure sensors 12a to 12d as the correction values at each tilt level.

For example, when the tilt level is a level θ (i.e. when the tilt angle θ1=0°), the panel controller 17 acquires detection values z10 to z13 detected by the individual pressure sensors 12a to 12d. Then the panel controller 17 stores the individual detection values z10 to z13 acquired into a row corresponding to “θ2” in the correction table 16a (refer to (1) in FIG. 9).

The panel 11 is inclined at the mounting angle θ2 with respect to the vertical direction when the tilt level is the level θ (i.e. level where the tilt angle θ1=0°). Therefore, in such a case, the detection values acquired from the individual pressure sensors 12a to 12d are equal to loads applied to the individual pressure sensors 12a to 12d due to the gravity G when the inclination angle θ of the panel 11 is θ2.

Next, the panel controller 17 commands a panel drive 21 to increase the tilt level by one. When the panel drive 21 changes the tilt level to a level 1 (i.e. level where the tilt angle) θ1=°), the panel controller 17 acquires detection values z14 to z17 from the individual pressure sensors 12a to 12d. Then the panel controller 17 stores the individual detection values z14 to z17 acquired into a row corresponding to an angle of “θ2+20°” in the correction table 16a (refer to (2) in FIG. 9).

The panel 11 is inclined at the angle of θ2+20°, with respect to the vertical direction, when the tilt level is the level 1 (i.e. level where the tilt angle θ1=20°. Therefore, in such a case, the detection values acquired from the individual pressure sensors 12a to 12d are equal to loads applied to the individual pressure sensors 12a to 12d due to the gravity G when the inclination angle θ of the panel 11 is θ2+20°.

Then the panel controller 17 completes the correction table 16a by repeating a similar process for a level 2 and for a level 3.

As described above, the panel controller 17 may perform the calibration process in the state where the navigation apparatus 1a is mounted on the host vehicle. Concretely, the correction table 16a may be generated by acquiring the detection values detected by the individual pressure sensors 12a to 12d at each tilt angle θ of the panel 11 (here, the tilt angle θ1+the mounting angle θ2) and by relating the detection values acquired to the inclination angle θ of the panel 11 as the correction values. In such a manner, the correction values in consideration of the tilt angle θ1 and also the mounting angle θ2 can be stored beforehand.

Such a calibration process, like the method of determining the mounting angle θ2 described with reference to FIG. 8, is performed when the panel controller 17 has determined that the host vehicle is in the parking state. Moreover, the detection values detected by the pressure sensors 12a to 12d are acquired at all tilt levels in the above description. However, the method of acquiring the correction values is not limited to the method described above. For example, detection values of the pressure sensors 12a to 12d are acquired only at the tilt level 0 and the tilt level 3, and correction values for other tilt levels may be obtained by using interpolation (e.g. linear interpolation).

### <4. Third Embodiment>

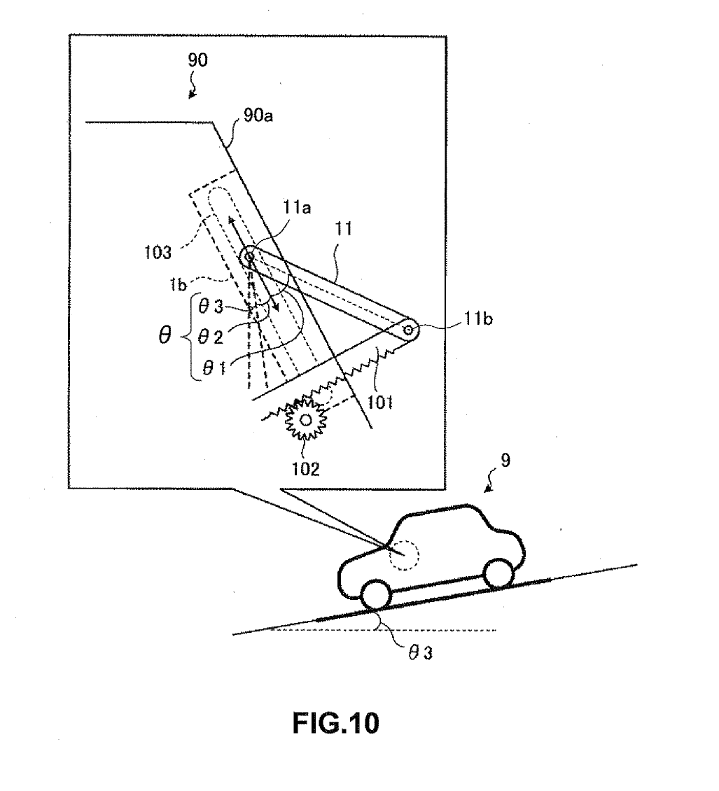

Next, the third embodiment is described. Since a navigation apparatus is mounted on a host vehicle, an inclination angle θ of a panel 11 changes as the host vehicle travels. FIG. 10 illustrates a situation where the host vehicle 9 on which a navigation apparatus 1b is mounted is inclined.

As shown in FIG. 10, the host vehicle 9 travels on a road surface sloped, for example, at an angle θ3 with respect to a horizontal direction. In the case, an actual inclination angle θ of the panel 11 is a sum value of a tilt angle θ1, a mounting angle θ2, and the angle θ3.

In the third embodiment, an example of a case where the inclination angle θ of the panel 11 is identified in consideration of the inclination angle θ3 of the host vehicle 9. The inclination angle θ3 of the host vehicle 9 with respect to the horizontal direction is hereinafter referred to as a vehicle angle θ3. Moreover, the horizontal direction means a direction orthogonal to a vertical direction.

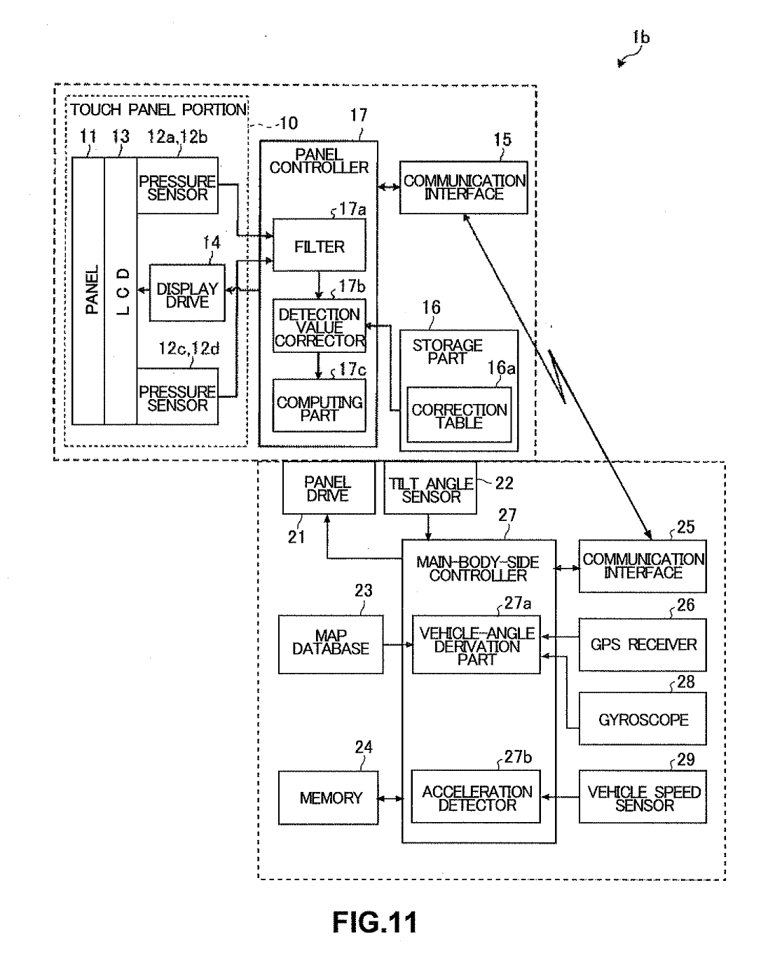

First, a configuration of the navigation apparatus 1b in the third embodiment is described with reference to FIG. 11. FIG. 11 is a block diagram illustrating the configuration of the navigation apparatus 1b in the third embodiment.

As shown in FIG. 11, the navigation apparatus 1b further includes a gyroscope 28 and a vehicle speed sensor 29. Moreover, a main-body-side controller 27 includes a vehicle-angle derivation part 27a and an acceleration detector 27b.

The gyroscope 28 is a sensor that detects an inclination angle of the navigation apparatus 1b with respect to the horizontal direction. A detection value detected by the gyroscope 28 is output to the vehicle-angle derivation part 27a. Instead of the gyroscope 28, a gravity sensor (a sensor that detects an inclination of a weight held to move freely, etc.) may detect the inclination angle of the navigation apparatus 1b with respect to the horizontal direction.

The vehicle speed sensor 29 is a sensor that detects a speed of the host vehicle 9 (hereinafter referred to as “vehicle speed”). A detection value detected by the vehicle speed sensor 29 is output to the acceleration detector 27b.

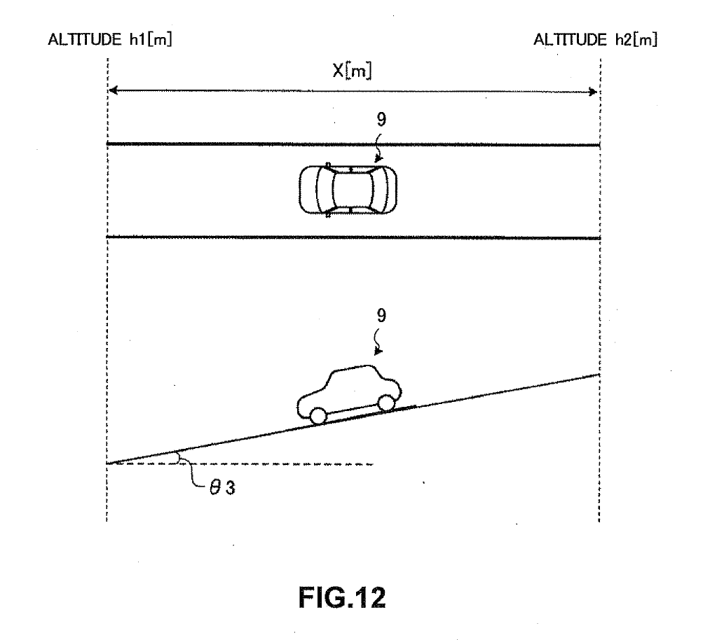

The vehicle-angle derivation part 27a is a processing part that derives the vehicle angle 03. Here, an example of a vehicle-angle derivation process is described with reference to FIG. 12. FIG. 12 illustrates the example of the vehicle-angle derivation process.

As shown in FIG. 12, the vehicle-angle derivation part 27a is capable of computing a slope angle of a road surface on which the host vehicle 9 travels, based on, for example, position information acquired from a GPS receiver 26 and on the map database 23, and of determining the slope angle of the road surface computed, as the vehicle angle θ3.

Concretely, the vehicle-angle derivation part 27a identifies a present position and a traveling direction of the host vehicle 9, by using the position information acquired from the UPS receiver 26. The main-body-side controller 27 is capable of identifying the traveling direction of the host vehicle 9 based on a direction in which the present position of the host vehicle 9 shifts.

Moreover, the vehicle-angle derivation part 27a identifies an altitude h1 (m) of a point located ahead of the present position of the host vehicle 9, an altitude h2 (m) of a point located behind the present position of the host vehicle 9, and a distance x (m) between the two points, based on the map database 23. Then the vehicle-angle derivation part 27a computes the slope angle of the road surface, based on a trigonometric function using values of h1, h2, and x. The vehicle-angle derivation part 27a derives the slope angle as the vehicle angle θ3.

The vehicle angle θ3 derived by the vehicle-angle derivation part 27a is output to a panel controller 17 via a communication interface 25. Thus in the panel controller 17, a detection value corrector 17b identifies a sum value of the tilt angle θ1, the mounting angle θ2, and the vehicle angle θ3 as the inclination angle θ of the panel 11, and corrects the detection values detected by individual pressure sensors 12a to 12d, based on the inclination angle θ identified. The detection value corrector 17b may identify a sum value of the tilt angle θ1 and the vehicle angle θ3 as the inclination angle θ of the panel 11.

In such a manner, when the slope angle of the road surface is derived as the vehicle angle θ3, based on the position information acquired from the GPS receiver 26 and on altitude information included in the map database 23, the vehicle angle θ3 can be determined without a measurement device such as the gyroscope 28.

The vehicle-angle derivation part 27a is also capable of deriving the vehicle angle θ3 by using a detection value detected by the gyroscope 28. In this case, the vehicle angle θ3 may be derived by subtracting the tilt angle θ1 and the mounting angle θ2 (i.e. an original inclination angle of the navigation apparatus 1b) and the tilt angle θ1 from the detection value detected by the gyroscope 28 (i.e. an inclination angle of the navigation apparatus 1b at a present time).

The acceleration detector 27b is a processing part that detects an acceleration of the host vehicle 9 based on a vehicle speed which is a detection value detected by the vehicle speed sensor 29, and that outputs the acceleration detected by the vehicle speed sensor 29, to the panel controller 17. When the navigation apparatus 1b includes an acceleration sensor, the detection value detected by the acceleration sensor may be output to the panel controller 17. In this case, the navigation apparatus 1b may not include the vehicle speed sensor 29 or the acceleration detector 27b.

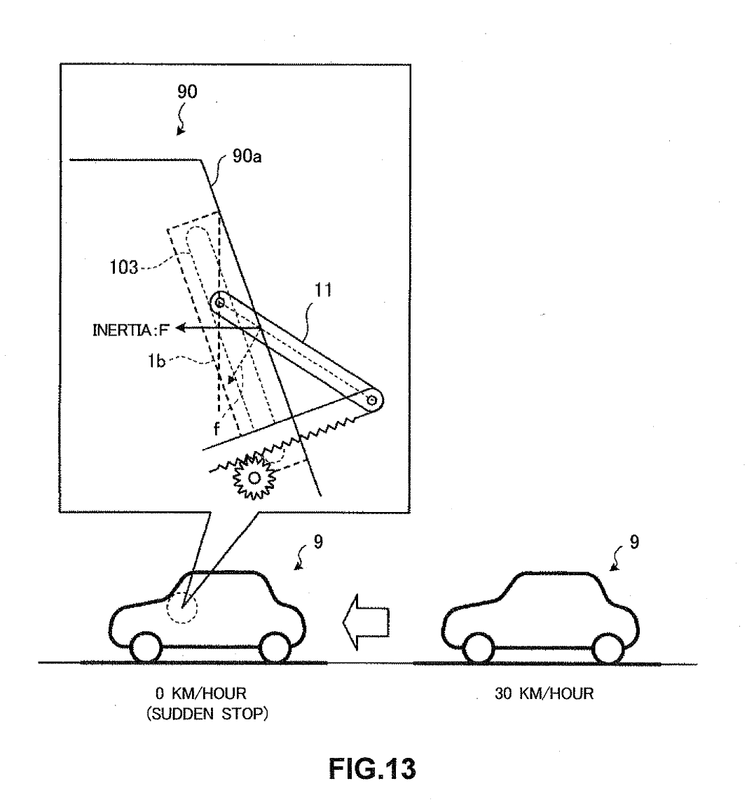

Here, the panel controller 17 is capable of changing the correction values that are subtracted from the detection values detected by the individual pressure sensors 12a to 12d, by using information of the acceleration output from the main-body-side controller 27. Such a case is hereinafter described with reference to FIG. 13. FIG. 13 illustrates a situation example where an inertia F acts on a touch panel portion 10.

As shown in FIG. 13, there is a case where the inertia F caused by acceleration or deceleration of the host vehicle 9 acts on the touch panel portion 10 during traveling of the host vehicle 9. For example, when the host vehicle 9 traveling at 30 km/hour makes a sudden stop, the inertia F acts on the touch panel portion 10 in a direction where the panel 11 is pressed. A force of the inertia F depends on an acceleration acting on the panel 11 (i.e. the acceleration of the host vehicle 9).

In such a case, since the individual pressure sensors 12a to 12d detect a load according to a component of the inertia F (a component f normal to an operation surface of the panel 11), there is a possibility that the operation position and the operation pressure may be detected incorrectly.

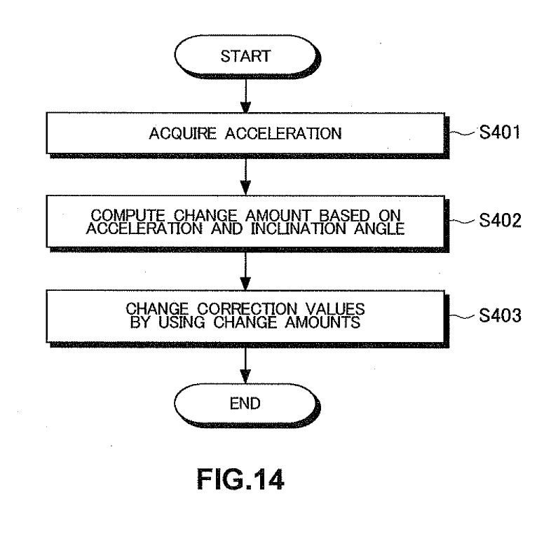

Therefore, the detection value corrector 17b may change the correction values for the detection values detected by the individual pressure sensors 12a to 12d, in accordance with the acceleration of the host vehicle 9, when correcting the detection values detected by the pressure sensors 12a to 12d. A procedure for a process that changes correction values (correction-value changing process) is described with reference to FIG. 14. FIG. 14 is a flowchart illustrating the procedure of the correction-value changing process.

As shown in FIG. 14, the detection value corrector 17b acquires the acceleration of the host vehicle 9 from the main-body-side controller 27 (a step S401). The detection value corrector 17b computes a change amount for each of the correction values, based on the acceleration acquired and the inclination angle θ of the panel 11 at a present time (a step S402).

For example, a table relating the change amount for each of the correction values to a combination of the inclination angle θ of the panel 11 and the acceleration, is stored beforehand for each of the pressure sensors 12a to 12d. The detection value corrector 17b acquires the change amount for each of the correction values corresponding to the combination of the inclination angle θ of the panel 11 and the acceleration acquired from the main-body-side controller 27, for each of the pressure sensors 12a to 12d, by using the table.

Moreover, the detection value corrector 17b changes the correction values by using the change amounts computed (a step S403).

As described above, the detection value corrector 17b may change the correction values for the detection values detected by the individual pressure sensors 12a to 12d, based on the acceleration of the host vehicle 9 detected by the vehicle speed sensor 29 and by the acceleration detector 27b. As a result, an influence of the inertia F caused by acceleration or deceleration of the host vehicle 9 can be removed. Thus the incorrect detection of the operation position and the operation pressure can be prevented more surely.

As described above, in the third embodiment, since the detection value corrector 17b identifies the inclination angle θ of the panel 11 by additionally using the vehicle angle θ3, the inclination angle θ of the panel 11 can be identified accurately even when the host vehicle 9 itself is inclined during traveling or the like of the host vehicle 9.

### <5. Modifications>

In the aforementioned description, some embodiments of an operation apparatus relating to the invention are described in detail with reference to the drawings. The embodiments are examples, and the invention can be carried out in various modifications and other improved forms, based on knowledge of those skilled in the art.

For example, in each of the aforementioned embodiments, the invention is described, taking a navigation apparatus in which the tilt angle θ1 of the touch panel portion 10 is adjustable, as an example. However, the invention is not limited to be used for the navigation apparatus but can be also used for navigation apparatuses in which the tilt angle θ1 is fixed.

In such a case, a detection value corrector identifies the mounting angle θ2, the vehicle angle θ3, or a sum value of θ2+θ3, as an inclination angle θ of a panel 11, and corrects detection values detected by individual pressure sensors 12a to 12d, in accordance with the inclination angle θ identified.

In the case, a correction table relates correction values for the individual pressure sensors 12a to 12d to one inclination angle θ identified. Moreover, a detection value corrector 17b does not need to acquire the tilt angle θ1 from a tilt angle sensor 22. The detection value corrector 17b corrects the detection values detected by the individual pressure sensors 12a to 12d by using only the correction table. Furthermore, the calibration process described with reference to FIG. 9 is performed only for the one inclination angle θ.

In addition, in the aforementioned embodiments, the correction table is generated by performing the calibration process when the navigation apparatus mounted on the host vehicle 9 is first activated. However, a timing of performing the calibration process is not limited to the time when the navigation apparatus mounted on the host vehicle 9 is first activated. For example, the calibration process may be performed when a frequency of incorrect operations made by a user exceeds a predetermined threshold.

The navigation apparatus is capable of detecting, for example, a percentage of a predetermined operation (e.g. a cancellation operation) to all user entry operations, as the frequency of the user incorrect operations.

Moreover, it is possible to apply a method of correcting the detection values detected at a time of a user operation, based on the detection values detected by individual pressure sensors immediately before the user operation, by regularly monitoring (monitoring at a predetermined relatively short time interval in which an after-mentioned process can be performed) output signals from the individual pressure sensors. For example, values are derived by subtracting detection values detected by the individual pressure sensors immediately before the user operation, from detection values detected by the individual pressure sensors at the time of the user operation. The values can be used as corrected detection values of the individual pressure sensors at the time of the user operation.

Differences between the detection values at the time of the user operation and the detection values immediately before the user operation are true detection values. Therefore, correct detection values can be obtained by using the detection values detected immediately before the user operation as the correction values and by performing an arithmetic processing using the detection values detected at the time of the user operation and the detection values detected immediately before the user operation. As a result, a state of the user operation can be detected accurately. A method of obtaining appropriate detection values is not limited to the method using the differences between the detection values detected before and at the time of the user operation. An appropriate arithmetic expression using the detection values detected before and at the time of the user operation as parameters, may be used. Such an arithmetic expression can be obtained from an experiment, etc. Moreover, it is possible to use a method of deriving the detection values by performing a process of selecting the detection values by referring to a table that includes the detection values detected before and at the time of the user operation as parameters.

As described above, the technology for an operation apparatus described above is effective when it is desired to detect a user operation accurately even when an operation surface of a panel is inclined. Especially, the technology is suitable to be used for a vehicle-mounted apparatus such as a navigation apparatus.

While the invention has been shown and described in detail, the foregoing description is in all aspects illustrative and not restrictive. It is therefore understood that numerous other modifications and variations can be devised without departing from the scope of the invention.

What is claimed is:

1. An operation apparatus, comprising:
a panel that a user presses for a user operation;
a pressure sensor that is disposed in a vicinity of the panel and that senses pressure on the panel from the user pressing on the panel; and
a controller configured to (i) correct a detection value detected by the pressure sensor, in accordance with an inclination angle that is an angle, with respect to a vertical direction, of the panel, and (ii) detect a state of the user operation on the panel, based on the detection value that has been corrected by the controller.

2. The operation apparatus according to claim 1, wherein
the controller detects a position that the user presses on the panel.

3. The operation apparatus according to claim 1, wherein
the controller detects a pressure with which the user presses on the panel.

4. The operation apparatus according to claim 1, further comprising
a panel drive configured to change a tilt angle of the panel,
wherein the controller corrects the detection value detected by the pressure sensor, based on the tilt angle of the panel.

5. The operation apparatus according to claim 1, further comprising
a memory that stores a mounting angle that is an angle, with respect to the vertical direction, of the panel mounted to a mounted member,
wherein the controller corrects the detection value detected by the pressure sensor, based on the mounting angle.

6. The operation apparatus according to claim 1, wherein
the controller is configured to derive a vehicle angle that is an angle, with respect to a horizontal direction, of a vehicle to which the panel is mounted, and
the controller corrects the detection value detected by the pressure sensor, based on the vehicle angle.

7. The operation apparatus according to claim 1, further comprising
a memory that stores correction information corresponding to the detection value detected by the pressure sensor in a state where the user operation on the panel is not performed,
wherein the controller corrects the detection value detected by the pressure sensor, based on the correction information.

8. The operation apparatus according to claim 7, wherein
the memory stores the correction information for each of a plurality of inclination angles of the panel, and
the controller corrects the detection value detected by the pressure sensor, by using the correction information corresponding to a present inclination angle of the panel.

9. The operation apparatus according to claim 1, further comprising
a detector that detects an acceleration acting on the panel,
wherein the controller corrects the detection value detected by the pressure sensor, based on the detected acceleration acting on the panel and the inclination angle of the panel.

10. An operation detection method of detecting a state of a user operation, the operation detection method comprising the steps of
(a) correcting a detection value detected by a pressure sensor disposed in a vicinity of a panel that a user presses for the user operation, in accordance with an inclination angle that is an angle, with respect to a vertical direction, of the panel; and
(b) detecting the state of the user operation on the panel, based on the detection value that has been corrected.

11. The operation detection method according to claim 10, wherein
the step (b) detects a position that the user presses on the panel.

12. The operation detection method according to claim 10, wherein
the step (b) detects a pressure with which the user presses on the panel.

13. The operation detection method according to claim 10, wherein
the step (a) corrects the detection value detected by the pressure sensor, based on a tilt angle of the panel.

14. The operation detection method according to claim 10, wherein
the step (a) corrects the detection value detected by the pressure sensor, based on a mounting angle that is an angle, with respect to the vertical direction, of the panel mounted to a mounted member.

15. The operation detection method according to claim 10, wherein
the step (a) corrects the detection value detected by the pressure sensor, based on a vehicle angle that is an angle, with respect to a horizontal direction, of a vehicle on which the panel is mounted.

16. The operation detection method according to claim 10, wherein
the step (a) corrects the detection value detected by the pressure sensor, based on correction information corresponding to the detection value detected by the pressure sensor in a state where the user operation on the panel is not performed.

17. The operation detection method according to claim 16, further comprising
acquiring the correction information corresponding to a present inclination angle of the panel, from a memory storing the correction information for each of a plurality of inclination angles of the panel,
wherein the step (a) corrects the detection value detected by the pressure sensor, by using the correction information corresponding to the present inclination angle of the panel.

18. The operation detection method according to claim 10, wherein
the step (a) corrects the detection value detected by the pressure sensor, based on an acceleration acting on the panel and the inclination angle of the panel.
